(19) United States
(12) Patent Application Publication
(10) Pub. No.: US 2010/0173278 A1
(43) Pub. Date: Jul. 8, 2010

(54) MICROCAPSULES CONTAINING MAMMALS' SPERMATOZOIDS, INSEMINATION DOSE CONTAINING SAME AND METHOD FOR OBTAINING SAME

(75) Inventor: Bruno Nihouam, Bedee (FR)

Correspondence Address: LERNER, DAVID, LITTENBERG,;KRUMHOLZ & MENTLIK, 600 SOUTH AVENUE WEST, WESTFIELD, NJ, 07090, US

(73) Assignee: Cooperative Bretonne D'Insemination Artificielle Porcine, Saint Gilles (FR)

(21) Appl. No.: 12/663,775

(22) PCT Filed: Jun. 12, 2008
(86) PCT No.: PCT/EP08/57386

§ 371 Date: Dec. 9, 2009

(30) Foreign Application Priority Data
Jun. 14, 2007 (FR) 07/04244

(51) Int. Cl. A01N 1/02

(52) U.S. Cl. 435/2

(57) ABSTRACT

The invention particularly relates to microcapsules comprising: a core containing mammals', but not human, spermatozoids in suspension in a diluter, i.e. a liquid medium capable of preserving spermatozoids; an encapsulation matrix made of a polymeric material. The microcapsules are characterised in that said matrix is non-spermicidal and is made of at least one semi-synthetic glyceride, i.e. at least one glyceride of C8-C18 saturated fatty acids having a fusion temperature of about 35 to 47° C. The invention also relates to an insemination dose containing such microcapsules, and to a method for producing the same.

The present invention relates to microcapsules containing spermatozoa of mammals.

It also concerns an insemination dose in which they are contained and a method to obtain these microcapsules.

Regarding the particular case of sows, the onset of heat occurs on average 30 hours before ovulation and translates physiologically as dilation of the cervix.

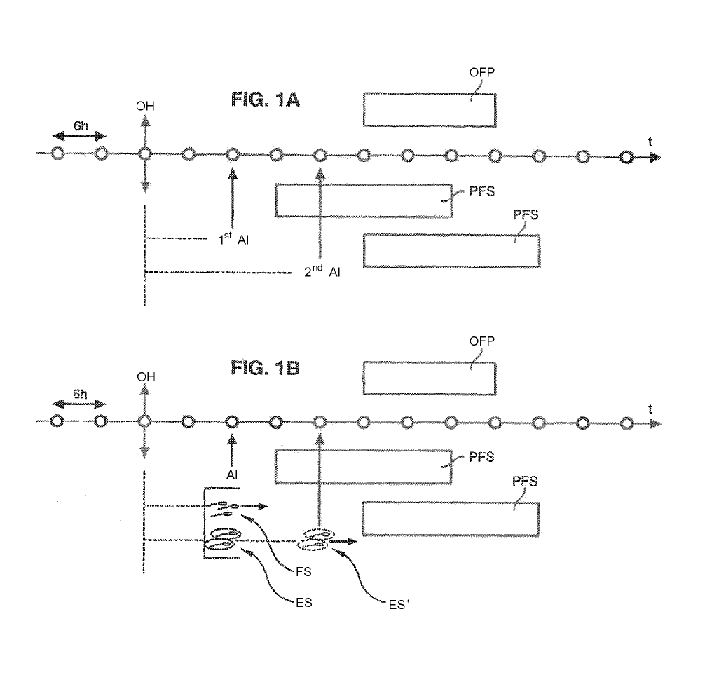

Reference is made to appended FIG. 1A which plots the time axis t, an interval lying in two neighbouring circles representing 6 hours.

On this axis, the onset of heat is referenced OH and block OFP represents the period of time during which the ovules are potentially fertilizable.

At the current time, artificial insemination is conducted in two stages, to cover the ovulation period and the post-ovulation period, in order to have the best chance of achieving fertilization of the ovules.

A first artificial insemination (1^{st} AI) is made 12 hours after the onset of heat OH which ensures a fertilizing period of 24 hours (first block, PFS). A second artificial insemination (2^{nd} AI) is made 24 hours after the onset of heat, which also ensures 24 hours of fertilization (2^{nd} block, PFS) which therefore covers the ovulating period OFP.

It will easily be appreciated that this conducting of artificial insemination in two stages requires numerous handling operations for the technician in charge of these inseminations. Also, this causes stress for sows. Finally, these operations require the need to use several containers for the sperm, which globally increases the cost price of the operation.

It has already been proposed to replace the two insemination operations by a single operation.

To do so, recourse has been made to encapsulating sperm in a non-toxic matrix which forms a gel or a solid at storage temperature and disintegrates at body temperature.

Document U.S. Pat. No. 4,840,891 for example describes encapsulation of spermatozoa for artificial insemination.

In this document, a hydrophilic, non-toxic polymer is used which is preferably chosen from the group consisting of polyurethane and polyoxyethylene polymers and from polyurethane and polyester polymers.

Also, document EP-B-0 922 451 describes a technique to encapsulate swine spermatozoa using polymer gels and in particular alginate gels.

This technique does not give good results insofar as the tests performed are not conclusive. The size of the formed microcapsules is in the order of 5 millimeters which is too big, and the motility of the encapsulated spermatozoa is much lower than the motility of free spermatozoa.

Other documents describe encapsulation techniques for spermatozoa. These are, but not limited to, the following documents:
U.S. Pat. No. B1-6,596,310
U.S. Pat. No. 4,840,891
WO 2006/106400
NEBEL RAYMOND L et al: “Spermatozoal microencapsulation for use in artificial insemination of farm animals” APPLICATIONS OF CELL IMMOBILISATION BIOTECHNOLOGY SPRINGER PO BOX 17, 3300 AA DORDRECHT, NETHERLANDS SERIES: FOCUS ON BIOTECHNOLOGY, 2005, pages 539-548, SP009073250 ISSN: 1-4020-3229-3(H),
TORRE M L et al: “Controlled release of swine semen encapsulated in calcium alginate beads” BIOMATERIALS, ELSEVIER SCIENCE PUBLISHERS BV., BARKING, GB, vol. 21, no. 14, July 2000 (2000-07), pages 1493-1498, XP004199070 ISSN: 0142-9612.

Additionally, the documents indicated below disclose techniques to encapsulate non-living materials:
WO 00/61119 A,
EP-A-1 693 445,
TIMBERT R et al: “Effect of sole and combined pre-treatments on reserve accumulation, survival and germination of encapsulated and dehydrated carrot somatic embryos” PLANT SCIENCE (SHANNON), vol. 120, no. 2, 1996, pages 223-231, XP002466575 ISSN: 0168-9452.
DINARVAND R et al: “Effect of surfactant HLB and different formulation variables on the properties of poly-D,L-lactide microspheres of naltrexone prepared by double emulsion technique” JOURNAL OF MICROENCAPSULATION ISSN: 0265-2048,
KHANDARE J N et al: “Preparation and evaluation of nimesulide niosomes for topical application” INDIAN DRUGS 2001 INDIA, vol. 38, no. 4, 2001, pages 197-202, XP009094333 ISSN: 0019-462X.

The idea of encapsulating part of an insemination dose entails the need to meet certain requirements. In particular, integration of the sperm in the capsules must allow controlled release thereof, and consequently replacement of the second insemination.

The capsules produced must be held in the liquid carrier medium in which they are contained (isotonic medium) for a minimum time of three days, and in the animal medium for 24 hours. These capsules must disintegrate within 6 hours in the animal medium and must have a size of around 1 mm.

For simplification purposes, the term “diluent” will be used to designate the isotonic medium in which the capsules are contained. This diluent is of well-known type to ensure preservation of fresh semen for several days.

To summarize, the encapsulating matrix must not react for at least 96 hours i.e. 72 hours in the isotonic medium and 24 hours in the animal medium.

This situation is shown in appended FIG. 1B, which is similar to the preceding figure. AI designates the only insemination conducted, during which the encapsulated spermatozoa ES are injected.

Reference ES′ relates to the period after which the encapsulation matrix starts to disintegrate, the full release of the spermatozoa occurring after 24 h.

The present applicant has ascertained that the use of a non-spermicidal matrix consisting of at least one semi-synthetic glyceride, namely at least one glyceride of C₈ to C₁₈ saturated fatty acids, with a melting point of between around 35° C. and around 47° C. fully meets the above-described objective.

Said encapsulation matrix is biocompatible with semen, stable in the isotonic medium for three days, stable for 24 hours in the intra-uterine animal medium at temperatures in the order of 38° C., and disintegrates within around 6 hours in the animal medium.

The present invention also relates to an insemination dose comprising a liquid medium able to ensure preservation of spermatozoa, this dose containing microcapsules conforming to one of the above-cited characteristics.

According to particular embodiments of this dose:
said liquid medium, in suspension, contains free spermatozoa FS i.e. non-encapsulated;
it contains at least two groups of microcapsules which differ two-by-two in type of liquid medium and/or type of said matrix;
said non-encapsulated liquid medium contains an agent able to allow the uniform placing in suspension of the microcapsules therein;
said agent is a gel;
said agent is a gellan gum.

The present invention also relates to a method to fabricate said microcapsules according to which the microcapsules are received in a solidifying bath.

According to the invention, the bath comprises a surfactant.

According to particular characteristics of this method:
said surfactant is a sorbitan monolaureate;
the temperature of the solidifying bath lies between 8 and 25° C.

Other characteristics and advantages of the present invention will become apparent from the following detailed reading of some preferred embodiments.

This description will be made with reference to the appended drawings in which:

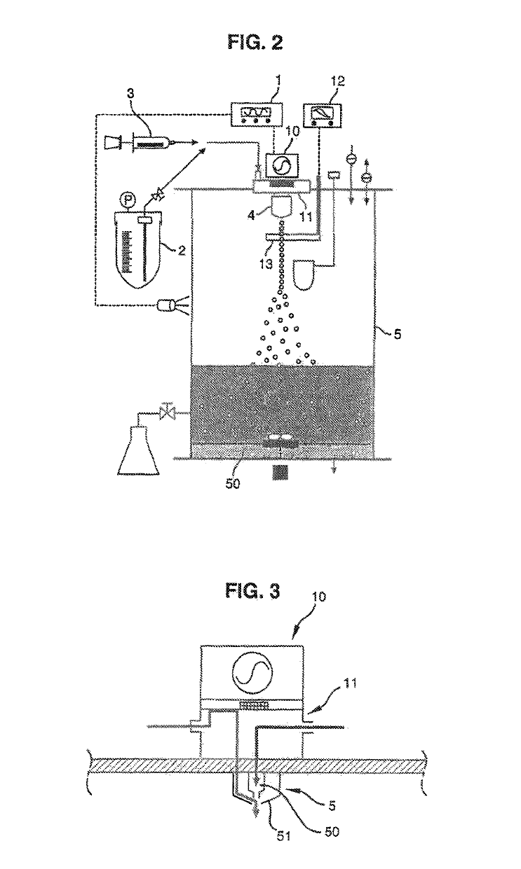

FIG. 2 is a schematic view of an installation used to fabricate microcapsules of the invention;

FIG. 3 is a view in detail of part of the installation shown FIG. 2.

1—Choice of Matrices:

The present applicant has tested several fats, and finally chose several matrices capable of forming the encapsulating material for the microcapsules of the invention.

They all concern non-spermicidal materials consisting of at least one glyceride of C₈ to C₁₈ saturated fatty acids which have a melting point of between around 35° C. and around 47° C.

More precisely, the tested products chosen are the following: (designated under their commercial references available from GATEFOSSE): Gelucire 39/01, Gelucire 43/01 and Suppocire DM.

The composition and characteristics of these products are as follows:

| | Gelucire 39/01 | | Gelucire 43/01 | | Suppocire DM | |
|---|---|---|---|---|---|---|
| Drop point | 37.5 to 41.5° C. | | 42.0 to 45.0° C. | | 42.0 to 45.0° C. | |
| (Mettler) | | | | | | |
| Acid number | <0.20 | mgKOH/g | <0.20 | mgKOH/g | <0.20 | mgKOH/g |
| Saponification | 225 to 245 mgKOH/g | | 214 to 236 mgKOH/g | | 214 to 236 mgKOH/g | |
| number | | | | | | |
| Iodine number | <2 gl2/100 g | | <2 gl2/1,000 g | | <2.0 gl2/100 g | |
| Hydroxyl number | <10 | mgKOH/g | <10 | mgKOH/g | <10 | mgKOH/g |
| Peroxide number | <1.2 | meq02/kg | <3.0 | meq0²/kg | <3.0 | meq0²/kg |
| Alkaline | <30 | ppm NaOH | <30 | ppm NaOH | <30 | ppm NaoH |
| impurities | | | | | | |
| Water content | <0.50% | | <0.50% | | <0.50% | |
| Sulfuric ash | <0.05% | | <0.6% | | <0.6% | |
| Unsaponifiable | <0.5% | | <0.05% | | <0.05% | |
| content | | | | | | |
| Heavy metals | <10 | ppm | <10 | ppm | <10 | ppm |

These materials prove to be satisfactory in terms of biocompatibility with semen and melting point.

2—Formation of Beads from Matrices:

The objective of this test is to determine favorable conditions for the formation of beads when extruding the matrices. The solidification of the beads must be rapid and depends upon the bath in which the capsules are received (temperature, surfactant, etc.).

Microcapsules of Gelucire 39/01 extruded using a syringe, were collected in a bath of distilled water at a temperature of 20° C., then 10° C.

In both cases, only a flat film was formed on the surface without any bead formation.

Under these conditions, several surfactants were tested in the bath receiving the beads, at different concentrations.

To conclude, and in particular on account of its non-spermicidal role with respect to semen and its lack of any harmful effect on the mobility and viability of the spermatozoa, Span 20 (registered trademark) was chosen (this is a sorbitan monolaurate).

A concentration in the order of 0.5 to 1 weight % is particularly preferred.

A summary of the tests conducted is given in the table at the end of the description.

3—Formation of Capsules:

The equipment used for encapsulation tests is apparatus called “Inotech Encapsulator IER-20” which is schematically illustrated FIG. 2.

The principle of this technique is based on the disintegration of a laminar jet into droplets by applying vibration.

The installation used comprises a frequency generator 1, associated with a device producing vibrations 10.

The raw materials of the microcapsules are respectively stored in a reservoir 2 and a syringe 3 and are conveyed as far as a nozzle 4 connected to a pulse chamber 11.

The microcapsules are collected in a reactor 5 of crystallization or beaker type at the bottom of which there is a low-power magnetic stirrer 50 to maintain the particles in movement.

An electric voltage generator 12 coupled to an electrode 13 is used to charge the very fine microcapsules to prevent them from sticking before gelling.

The nozzle 5 is called a “double nozzle” namely it comprises an “inner” nozzle 50 generating the core of the microcapsule and an “outer” nozzle 51 generating the matrix of the microcapsule (see FIG. 3).

a) Encapsulation of the Isotonic Medium: Diluent:

The first encapsulation tests were performed with a diluent (consisting of a preservation medium for animal semen, enriched with anti-oxidant molecules and containing an antibiotic) and Gelucire 39/01. Different parameters had to be adjusted to obtain optimal conditions for formation of capsules of homogeneous size, by minimizing loss of diluent during production.

b) Encapsulation of Semen:

1) The ejaculate was collected as a rich fraction then filtered through sterile gauze. The pure semen was controlled for concentration (Nucleocounter), motility (SCA) and morphology (count). The semen was pre-diluted (v:v) at 30° with long-life diluent supplemented with a viscosity agent. The final dilution was made with the same diluent at 20°. The diluted semen was stabilized for one hour at room temperature before being stored at 17° C. until the encapsulating process.

2) Optimisation of Operating Conditions

Several encapsulation tests were conducted to optimize the following operating parameters:
Semen flow rate;
Flow rate of the encapsulating matrix;
Cut-off frequency;
Voltage;
Distance of solidifying bath from the nozzles.

This optimization was based partly on theoretical calculations to allow prediction of flow rates at a given frequency and in relation to the physicochemical characteristics of the materials used (viscosity, surface tension, density, etc.).

The capsules formed during each experiment were examined under a microscope (inner and outer size, size distribution, shape).

4—Results and Discussion:

Several encapsulation tests of swine semen were conducted on site to avoid subjecting the semen to temperature changes due to transport.

a) Motility of the Encapsulated Spermatozoa

The method used (slicing with a scalpel) to release the spermatozoa from the capsule is not very precise and may cause destruction of the semen when handling. Nonetheless, it was observed in some cases that the motility of the encapsulated spermatozoa may reach 65%.

It is therefore estimated that the semen well withstands the encapsulation process and variations in heat during handling.

In other cases, very low motility was observed which may be due either to non-resistance of some semen (type of boar) or to the encapsulating process or scalpel method used.

b) Weight of a Capsule:

The weight of a capsule was estimated by weighing around one hundred capsules from different batches. The weight of one capsule lies between 0.8 and 1.2 mg.

c) Controlled Release of the Encapsulated Spermatozoa (In Vitro Test)

It was evidenced that the spermatozoa are released from the capsule on and after the first hour of incubation. Maximum concentration is reached after 20 to 30 hours for capsules having a core diameter of 0.6 to 0.9 mm and a total diameter of 1 mm.

5. Suspending of the Capsules During Storage

It was found that when the beads were incubated in the presence of the semen, they were not homogeneously distributed within the dose and formed a layer on the surface of the diluted semen. This may have a harmful effect on preservation of the semen.

The objective of this study is to add texturizing agents to the medium (diluents) so as to be able to hold the beads in suspension.

On account of its non-spermicidal characteristics, a gellan gum was chosen. The gum known under the trade name KELCOGEL LT 100 (by CP Kerlco) is fully suitable. It allows excellent holding in suspension of the beads when its concentration is in the order of 0.05%.

| | | Surfactant | | Capsule | | Bio- | |
|---|---|---|---|---|---|---|---|
| Tests | Surfactant | concentration | Matrix | formation | Shape | compatibility | Chosen |
| 1 | NI 24-7 | 1% | Gelucire | Yes | Spherical | No | No |
| | | | 43/01 | | | | |
| 2 | NI 45-8 | 1% | Gelucire | Yes | Spherical | No | No |
| | | | 43/01 | | | | |
| 3 | Tween 85 | 0.% | Gelucire | No | Semi- | Yes | No |
| | | | 43/01 | | spherical | | |
| 4 | Tween 85 | 0.5% | Gelucire | No | Flat | Yes | No |
| | | | 43/01 | | | | |
| 5 | Tween 85 | 1% | Suppocire | No | Flat | Yes | No |
| | | | 43/01 | | | | |
| 6 | Tween 85 | 1% | Suppocire | No | Flat | Yes | No |
| | | | 43/01 | | | | |
| 7 | Tween 20 | 1% | Gelucire | No | Flat | Yes | No |
| | | | 43/01 | | | | |
| 8 | Tween 20 | 0.5% | Gelucire | No | Flat | Yes | No |
| | | | 43/01 | | | | |
| 9 | Span 20 | 1% | Gelucire | Yes | Spherical | Yes | Yes |
| | | | 43/01 | | | | |
| 10 | Span 20 | 1% | Suppocire | Yes | Spherical | Yes | Yes |
| | | | DM | | | | |
| 11 | Span 20 | 0.5% | Suppocire | Yes | Spherical | Yes | Yes |
| | | | DM | | | | |

* The surfactant is identified by the commercial reference or registered trademark under which it is available.

1. Microcapsules comprising:
a core containing spermatozoa of mammals, excepting the human being, in suspension in a diluent i.e. a liquid medium capable of ensuring preservation of the spermatozoa;
an encapsulation matrix consisting of a polymer material, characterized by the fact that said matrix is non-spermicidal and consists of at least one semi-synthetic glyceride namely at least one glyceride of C₈ to C₁₈ saturated fatty acids which has a melting point of between around 35 and around 47° C.

2. Insemination dose comprising a liquid medium capable of ensuring preservation of spermatozoa, characterized by the fact that it contains microcapsules conforming to claim 1.

3. Dose according to claim 2, characterized by the fact that said liquid medium contains free i.e. non-encapsulated spermatozoa in suspension.

4. Dose according to claim 2, characterized by the fact that it contains at least two groups of microcapsules which differ two-by-two in the type of liquid medium and/or type of said matrix.

5. Dose according to claim 2 to 4, characterized by the fact that said non-encapsulated liquid medium contains an agent capable of allowing the microcapsules to be placed in uniform suspension in the medium.

6. Dose according to claim 5, characterized by the fact that said agent is a gel.

7. Dose according to claim 6, characterized by the fact that said agent is a gellan gum.

8. Method to fabricate microcapsules according to claim 1, according to which said microcapsules are received in a solidifying bath, characterized by the fact that said bath contains a surfactant.

9. Method according to claim 8, characterized by the fact that said surfactant is a sorbitan monolaurate.

10. Method according to claim 9, characterized by the fact that the temperature of the solidifying bath lies between 8 and 25° C.
